(19) United States
(12) Patent Application Publication
(10) Pub. No.: US 2010/0091959 A1
(43) Pub. Date: Apr. 15, 2010

(54) MANAGING ACCESS TO ELECTRONIC MESSAGES

(75) Inventors: Yukari Miki, Yamato (JP); Masami Noguchi, Tokyo (JP)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/566,741

(22) Filed: Sep. 25, 2009

(30) Foreign Application Priority Data
Oct. 10, 2008 (JP) 2008-0263729

(51) Int. Cl. H04M 1/64; H04M 11/00

(52) U.S. Cl. 379/88.17; 379/93.02

(57) ABSTRACT

An electronic messaging system enables delivery of a stored message to a substitute recipient if the original intended recipient fails to access the message. When a message is being stored, the message originator is asked whether the originator will authorize making the stored message available to a substitute recipient if the original intended recipient fails to access the stored message within a predetermined period of time following storage. If the message originator provides such authorization, a substitute recipient is identified. The identity of the substitute recipient and the conditions under which the message will be made available to the substitute recipient are stored in association with the message. The message originator may be authenticated before the message is stored. The substitute recipient may be authenticated before the message is retrieved from storage for delivery to the substitute recipient.

### BACKGROUND

The present invention relates to managing access to electronic messages. Particularly, the present invention relates to managing access to electronic messages in cases where the electronic messages have not been accessed by the individuals to whom the messages were originally directed.

Corporations and other organizations rely heavily on electronic messaging systems, such as voicemail systems and e-mail systems. In such systems, recorded voice messages or e-mail messages are stored on messaging servers for later retrieval by intended recipients. Such systems are useful where a sender does not feel there is an immediate need for a response from an intended message recipient.

The intended recipient of a message is responsible for checking the recipient's own messaging in-box (allocated memory space on the messaging server) for stored messages. If an important message is sent but the intended recipient fails to check for messages for an extended period of time, the lack of any response from the intended recipient may have adverse consequences for the sender, the recipient and others.

Moreover, in at least some message systems, unchecked messages remain in a recipient's allocated memory on the messaging server. If a significant number of unchecked messages accumulate in the allocated memory, the allocated memory may be exhausted, causing the server reject even critical incoming messages directed toward an intended recipient.

### SUMMARY

One embodiment of the invention is a computer-implemented method for managing access to stored electronic messages in an electronic messaging system. When a message is presented for storage, a determination is made whether the message originator is willing to authorize release of the message to a substitute recipient if the original intended recipient does not access the message before a predetermined set of conditions occurs. If the authorization is provided, an authorized substitute recipient is identified. The identity is stored in memory in association with the message. When the predetermined set of conditions occurs, the identity of the substitute recipient is retrieved and the stored message is made available.

Another embodiment of the invention is a computer program product that includes a computer usable medium having computer usable program instructions recorded thereon. The program instructions, when loaded onto and executed by a computer, cause the computer to manage access to stored electronic messages in an electronic messaging system. When a message is presented for storage, a determination is made whether the message originator is willing to authorize release of the message to a substitute recipient if the original intended recipient does not access the message before a predetermined set of conditions occurs. If the authorization is provided, an authorized substitute recipient is identified. The identity is stored in memory in association with the message. When the predetermined set of conditions occurs, the identity of the substitute recipient is retrieved and the stored message is made available.

Another embodiment of the message is an apparatus including an input unit for receiving electronic messages from message originators for later retrieval and delivery to original intended recipients. The apparatus includes memory for storing the message, authorization of a substitute recipient if the message has not been accessed before a predetermined set of conditions occurs, the predetermined conditions and the identity of the substitute recipient. The apparatus also includes a memory management unit for determining whether the predetermined conditions occur before the message is accessed and for making the message available to the substitute recipient.

### BRIEF DESCRIPTION OF THE SEVERAL VIEWS OF THE DRAWINGS

FIG. 1 is a diagram illustrating a general configuration of a computer system in which an embodiment of the invention may be implemented.

FIG. 2 is a block diagram illustrating functional configurations of an IVR (Interactive Voice Response) apparatus, a message management apparatus, and a voiceprint authentication system included in one embodiment of the invention.

FIG. 3 is a table illustrating an example of message information used in an embodiment of the invention.

FIG. 4 is a diagram illustrating an example of substitute recipient information used in the embodiment of the invention.

FIG. 5 is a diagram illustrating an example of template information used in an embodiment of the invention.

FIG. 6 is a flowchart illustrating message registration and storage operations performed in an embodiment of the invention.

FIG. 7 is a flowchart illustrating operations for requesting that a substitute recipient access a stored message in an embodiment of the invention.

FIG. 8 is a schematic diagram of hardware components of a programmable computer that may be used to implement embodiments of the invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium having computer usable program code stored in the medium.

Any combination of one or more computer usable or computer readable storage medium(s) may be utilized. The computer usable or computer readable storage medium may be, for example but not limited to, an electronic, magnetic, optical, electromagnetic, infrared, or semiconductor system, apparatus, or device. More specific examples (a non-exhaustive list) of computer usable mediums would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer usable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable medium may be any medium that can contain or store the program for use by or in connection with the instruction execution system, apparatus, or device.

Computer program code or program instructions for carrying out operations of the present invention may be written in any combination of one or more programming languages, including an object oriented programming language such as Java, Smalltalk, C++ or the like and conventional procedural programming languages, such as the “C” programming language or similar programming languages. The computer program code may execute entirely on a user's computer as a stand-alone software package or as an integrated component of a larger software package, partly on the user's computer and partly on a remote computer or entirely on remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The following description will indicate where specific program code is or can be executed in a network of computer devices.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, alternatively referred to as computer program code, may also be stored in a computer usable or computer readable medium that can direct a computer or other programmable data processing apparatus to function in a particular manner, such that the instructions stored in the computer readable medium produce an article of manufacture including instruction means that implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide processes for implementing the functions/acts specified in the flowchart and/or block diagram block or blocks.

A mode for carrying out the invention (hereinafter, referred to as an “embodiment”) will be described in detail below with reference to accompanying drawings. The described embodiment relates to a voice message system and references to “message” or “messages” in the following description should be assumed to be references to voice messages. The invention is not limited to voice messaging and may be applied to other types of electronic messaging systems, including e-mail systems.

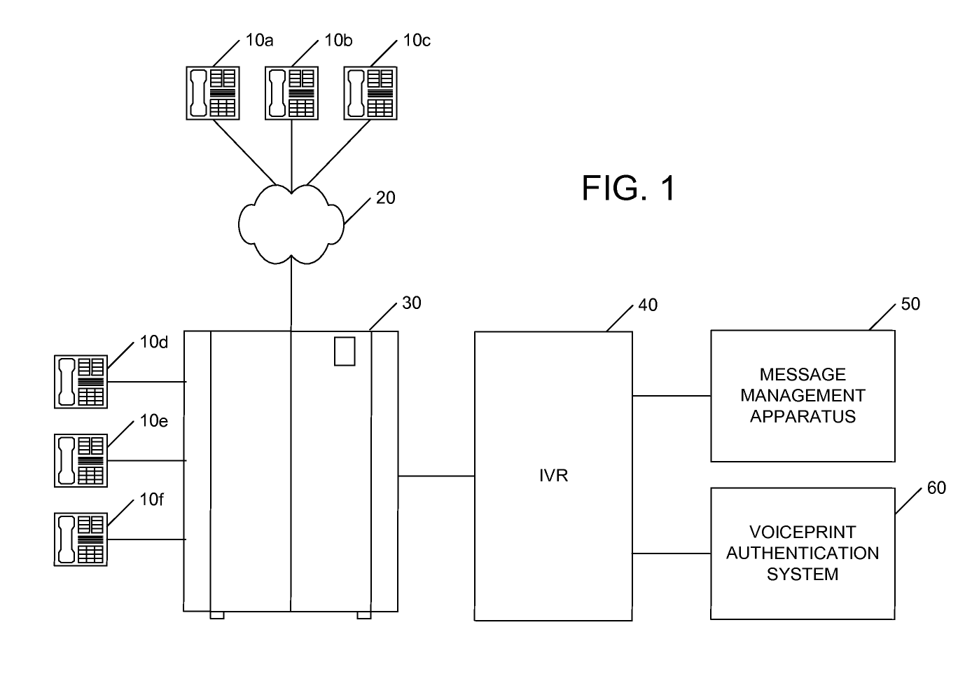

Referring to FIG. 1, the drawing shows a general configuration of a computer system in which an embodiment of the invention may be implemented.

The computer system includes telephone sets 10a to 10f, a public network 20, a private branch exchange (PBX) 30, an interactive voice response (IVR) unit 40, a message management apparatus 50, and a voiceprint authentication system 60.

The telephone sets 10a to 10f may be connected to the PBX 30 either indirectly via the public network 20, as shown for telephone sets 10a to 10c, or directly, as shown for telephone sets 10d to 10f, Although only six telephone sets 10 are shown in the drawing, many more telephone sets would exist in a typical system. The telephone sets 10a to 10f may be either wired telephones or wireless telephones. In the following description, the telephone sets 10a to 10f may be generically referred to “telephone set 10” from time to time.

The public network 20 is a general telephone subscriber line network. The PBX 30 is a private branch exchange. More specifically, the PBX 30 can be used to provide connections between internal telephone sets or between an internal telephone set and an external telephone set that accesses the PBX 30 through the public network 20. Moreover, the PBX 30 can receive or create voice messages (i.e., messages composed of digitized voice data) and direct those messages to the IVR unit 40

The IVR unit 40 is an automatic voice response system. The IVR can accept voice and keypad inputs from a telephone user and provide a predetermined synthesized voice response or perform a predetermined action in response to those inputs.

The message management apparatus 50 receives and registers voice messages originating with users of the telephone sets and stores those messages in predetermined storage locations, sometimes referred to as message boxes, for future retrieval by authorized telephone users.

The voiceprint authentication system 60 is used to authenticate a user who is trying to retrieve a stored message. The authentication process examines a voiceprint of the retrieving user to confirm the identity of the user before releasing the message stored in message management apparatus 50.

In this embodiment, a computer system having the above configuration makes it possible for a substitute recipient to retrieve a stored message where the message remains unopened for a certain period of time after having been registered in message storage. A substitute recipient for a particular stored message may be selected as a function of the identity of the message sender or message keywords or a combination of the two. Before actually being allowed to retrieve a stored message, a substitute recipient may be authenticated for security reasons.

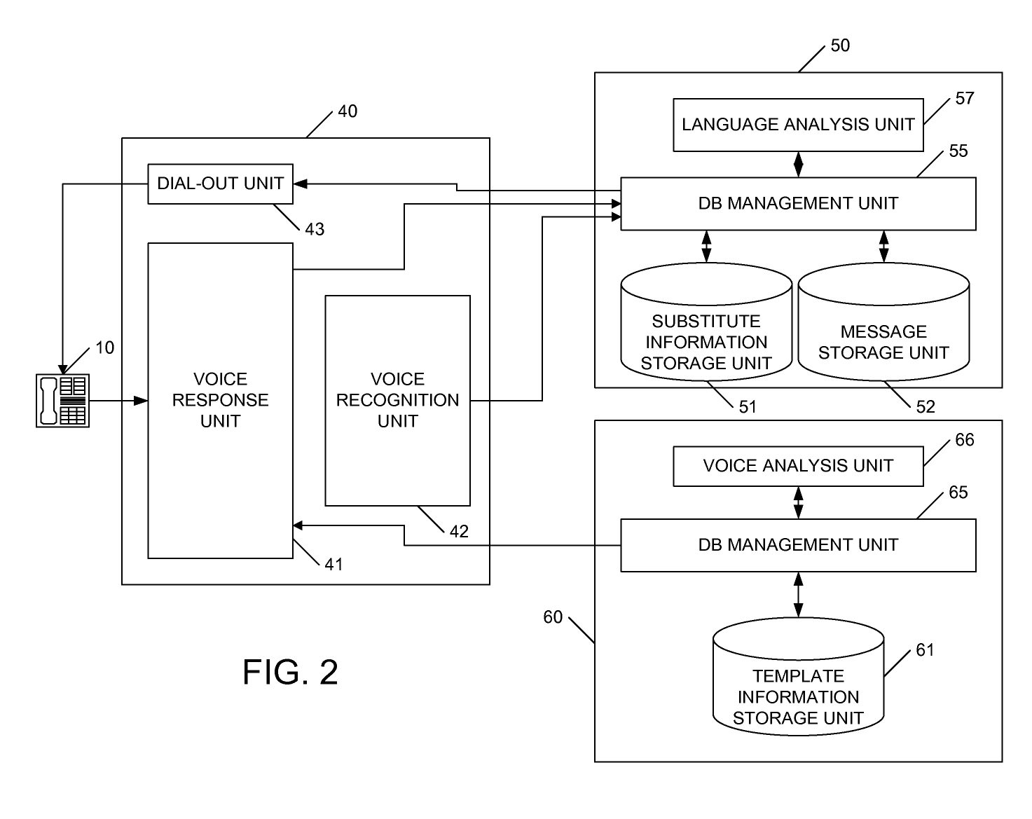

Referring to FIG. 2, examples of functional configurations of the IVR unit 40, the message management apparatus 50, and the voiceprint authentication system 60 are illustrated.

Referring first to IVR unit 40, the unit 40 includes a voice response unit 41, a voice recognition unit 42, and a dial-out unit 43.

The voice response unit 41 accepts keypad signals or a voice message originating from a telephone set 10 through the PBX 30 and may provide artificial or synthesized voiced responses for delivery to the telephone user. In embodiments of the invention, the voice response unit 41 passes accepted information on to the message management apparatus 50 and to the voiceprint authentication system 60. In the illustrated embodiment, voice messages included in the accepted information are output to the voice recognition unit 42.

The voice recognition unit 42 processes the message received from the voice response unit 41 in real time and converts the message into text that may later be used for purposes such as identifying the caller or extracting message-identifying information such as keywords.

The dial-out unit 43 transmits dial information to the PBX 30 to cause the PBX 30 to dial a specified phone number, for example, the telephone number of a delegated recipient.

The following describes the functional configuration of the message management apparatus 50. As shown, the message management apparatus 50 includes a message storage unit 51, a substitute recipient information storage unit 52, a database (DB) management unit 55, and a language analysis unit 57.

The message storage unit 51 stores message information including the address of a message storage location (or box) for actually storing a message received from the IVR 40, and the identity of a substitute recipient that may be called upon to retrieve the stored message.

The substitute recipient information storage unit 52 stores substitute recipient information including the identity of the message originator (caller), indications of the message subject matter (such as keywords), and the identity of a substitute recipient who may be called upon to retrieve messages that are from the identified caller and that deal with the identified subject matter.

The DB management unit 55 manages the message storage unit 51 and the substitute recipient information storage unit 52. For example, the DB management unit 55 stores voice messages received from the IVR 40 in the message storage unit 51 and can retrieve such stored messages for access by an identified and authenticated substitute recipient. Furthermore, the DB management unit 55 uses information stored in the substitute recipient information storage unit to identify the appropriate substitute recipient.

In the illustrated embodiment, the language analysis unit 57 analyzes message text generated by the voice recognition unit 42 to identify the message speaker and the subject matter of the message.

As shown, the voiceprint authentication system 60 includes a template information storage unit 61, a database (DB) management unit 65, and a voice analysis unit 66.

The template information storage unit 61 stores template information including a user id, an associated user name, and an associated template for use in voiceprint authentication.

The DB management unit 65 manages the template information storage unit 61. For example, the DB management unit 65 may retrieve a particular template for an identified substitute recipient.

The voice analysis unit 66 analyzes the characteristics of a voice provided by the voice recognition unit 42 of the IVR 40.

Message information that can be stored in the message storage unit 51 will be described in detail below.

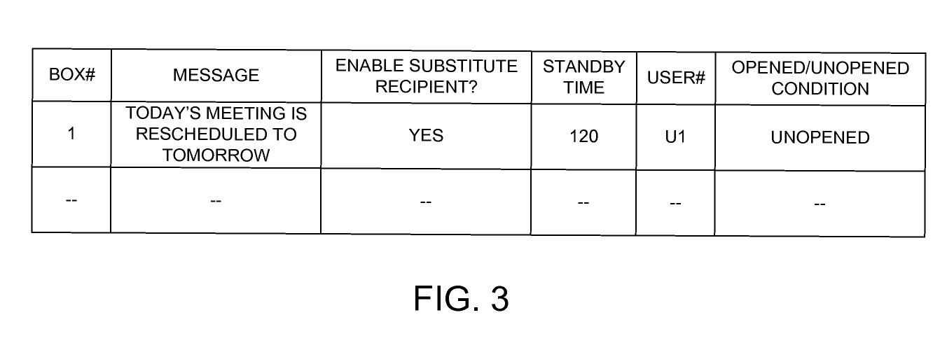

Referring to FIG. 3, the message information includes the address of a storage location or BOX#, memory for actually storing the message, an ENABLE SUBSTITUTE RECIPIENT indicator that controls whether or not the stored message may be made available to a substitute recipient, an associated STANDBY TIME (the amount of time the message must be in storage before a determination can be made whether to make the message available to a substitute recipient, an associated user ID or USER#, and an OPENED/UNOPENED message status indicator.

The box ID includes memory address information for uniquely identifying the message storage location and is denoted by “BOX#” in the drawing. Moreover, the Enable Substitute Recipient indicator may be set to “YES” if a substitute recipient may be authorized to access the stored message or “NO” if the caller does not wish the message to be made available to substitute recipients. Standby time (the time the message must remain in storage without being accessed before the system checks to see if a substitute recipient has been authorized) may be expressed in terms of minutes. For example, when “120” is set as shown, the system will not begin the process of identifying a substitute recipient and making the stored message available to the identified substitute receipt until 120 minutes have elapsed from the time the message was received and stored in the system. Moreover, the contents of the user ID are to be used to uniquely identify a substitute recipient. In the drawing, “U1” is set to the user ID and therefore the substitute having the user ID “U1” is requested to check the message. Furthermore, “UNOPENED” is set to the opened/unopened condition, and it means that the message is has not been accessed. If the message has been accessed, the opened/unopened condition is rewritten to “OPEN.”

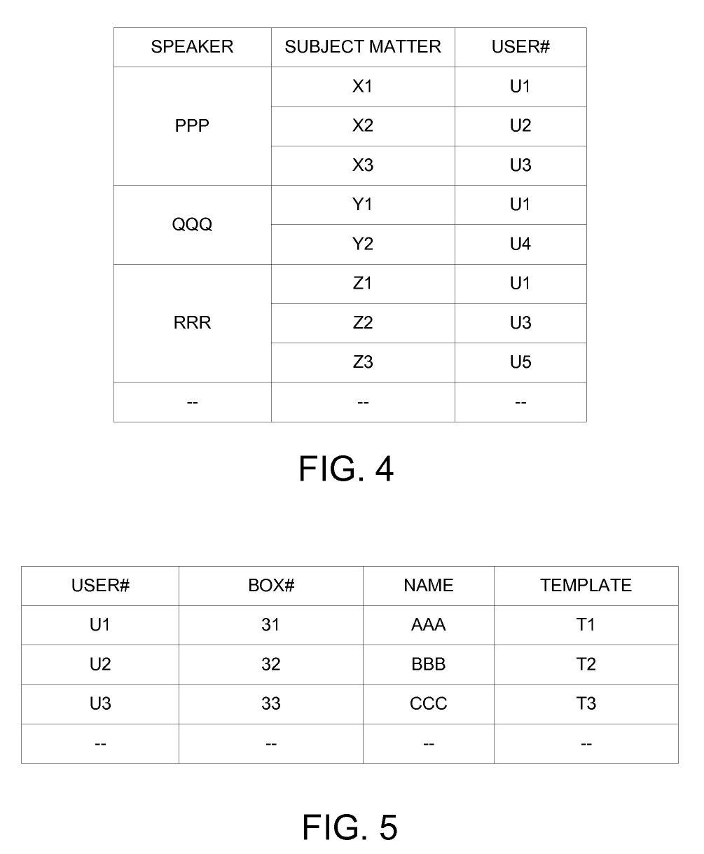

Substitute recipient information stored in the substitute information storage unit 52 will be described in detail below with reference to FIG. 4. As shown in that figure, the substitute recipient information includes fields identifying particular message originators, fields identifying message subject matter categories and substitute recipient user IDs that identify potential substitute recipients for messages that originate with particular message originators and deal with particular subject matters.

In the drawing, for example, for an originator PPP and a message relating to subject matter X1, substitute recipient U1 may be delegated the task of accessing the stored message. For the same originator PPP, messages on a different subject matters X2 and X3 may require different substitute recipients U2 and U3, respectively.

FIG. 5 is a table showing examples of entries in the template information storage unit 61 referred to earlier. Each entry can include a user ID, a box ID, a name, and a template, which are associated with each other. Template information may be stored for both callers (those leaving messages) and recipients (those retrieving stored messages). Recipients can include both intended and substitute recipients.

As described above, the USER# field contains information for uniquely identifying a user. The BOX# field contains the address of the system message storage location associated with that user. Caller records will always have an address entry in the BOX# field. Recipient records will include an address entry only if the identified user is authorized to leave messages as well as retrieve them. The NAME field will include the name of the user identified by the USER#. The TEMPLATE field contains data defining characteristics of the voice of the associated user. The data stored in the TEMPLATE field provides reference data for use in authenticating the user through analysis of the user's voice. In the drawing, the template is indicated by a simple notation such as “T1,” “T2,” or “T3,” but in practice the stored template typically includes many parameter values. As an alternative to storing the template data directly in the TEMPLATE field, that field may be used to store a pointer to another memory location in which the set of parameter values is actually stored.

Two operations are described below. The first operation is a message registration operation performed when a voice message is initially stored. The second operation is performed to determine whether a substitute recipient should be notified that a stored message needs to be accessed. The two operations are performed independently of each other.

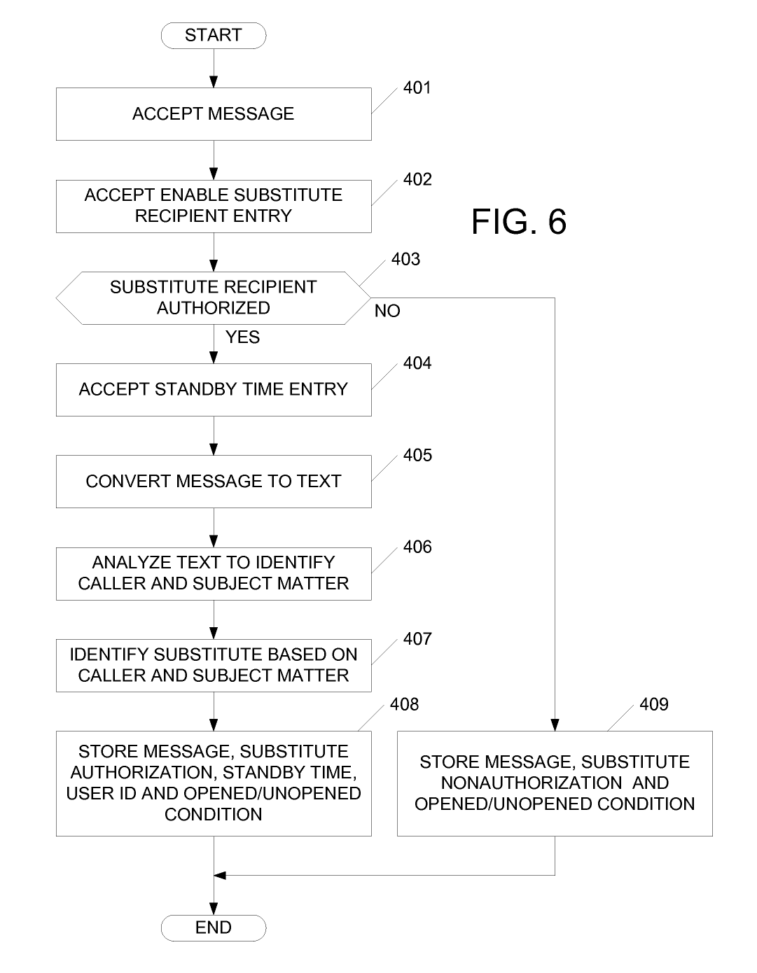

FIG. 6 is a flowchart of operations performed in the IVR 40 and the message management apparatus 50 when a caller leaves a voice message in the system for later retrieval by a recipient.

In the IVR 40, the voice response unit 41 accepts a caller's message for storage in step 401. For example, if the user speaks a message such as “Today's meeting is rescheduled to tomorrow,” the voice response unit 41 accepts the message. The message is directed to the DB management unit 55 of the message management apparatus 50 and also, in the embodiment being described, to the voice recognition unit 42.

Subsequently, the voice response unit 41 must determine whether the caller is willing to have the message made available to a substitute recipient. The voice response unit will normally provide a voice prompt to elicit a “yes” or “no” response from the caller. The “yes” or “no” response may take the form of keypad presses (e.g., 1=“yes”, 2=“no”) or spoken responses in systems including voice recognition capabilities. The caller's response is directed to the DB management unit 55 of the message management apparatus 50 (step 402).

The voice response unit 41 will analyze the caller's response (step 403) in order to determine whether more information must be obtained from the caller.

If the caller has authorized potential release of the stored message to a substitute recipient, the system must learn how long the caller wants to wait before steps are initiated that may lead to the release. The voice response unit 41 will prompt the caller to specify the standby time; i.e., the amount of time the message must remain in storage before release operations can be initiated. Again, the caller's response may be in the form of successive keypad presses expressing the standby time in minutes or voiced utterances. The caller's entry of standby time is accepted (step 404) and directed to the DB management unit 55 of the message management apparatus 50.

In order to identify a substitute recipient who may eventually be called upon to access the stored message, the described embodiment performs steps to identify the caller and determine the subject matter of the received message. More specifically, the voice recognition unit 42 converts the audio data form of the received message to text data form (step 405) and directs the text message to the DB management unit 55 of the message management apparatus 50. The DB management unit 55 sends the message text message to the language analysis unit 57, which analyzes the message text to identify the caller and the subject matter of the message (step 406).

Examples of steps that may be taken in identifying the caller and subject matter through text analysis follow. To identify a caller, the language analysis may identify organizational references (such as Department or Company) and examine words or phrases occurring just before or after the organization references to determine whether those words and phrases may include the caller's name.

The subject matter of a message may be determined by comparing words in the message to previously registered keywords and then selecting the most frequently occurring keyword as a subject matter indicator.

The caller's identity and the message subject matter are sent to the DB management unit 55, which accesses the substitute recipient information storage unit 52 to identify the substitute recipient associated with the identified caller and identified subject matter. For example, given the message “Today's meeting is rescheduled to tomorrow” and referring momentarily to FIG. 4, if the subject matter of that message is determined to be “X1” and the caller is identified as “PPP”, the DB management unit 55 will identify the appropriate substitute recipient as user “U1”.

After identifying the caller, the subject matter of the voice message, the standby time and the substitute recipient, the DB management unit 55 stores the message, the authorization of a substitute recipient, any entered standby time, and the identity of any substitute recipient in the message storage unit 51 and initializes and stores the current message condition or status as “UNOPENED” in step 408.

On the other hand, operation 403 had determined that the caller was not willing to authorize a substitute recipient, then the message, the lack of a substitute recipient authorization and the current message condition (initially “UNOPENED”) are stored in the message storage unit 51 in a step 409.

Although the described embodiment calls for the caller to enter a standby time indicating how long the message must remain in storage without being accessed before steps can be taken to identify a possible substitute recipient, it is within the scope of the invention to require that the caller directly specify the day and time at which steps can be initiated to identify a substitute recipient.

Moreover, while the above description states that a caller is to be identified by performing text analysis, the invention is not limited to that method of caller identification. Other methods of identifying the caller fall within the scope of the invention. For example, the caller may be identified on the basis of the telephone number from which the call originated. Similarly, the caller may be identified by analyzing the caller's voice.

Furthermore, although the described embodiment associates substitute recipients to specific combinations of callers and message subject matters, substitute recipients may be identified on other bases. For example, a substitute recipient may be associated to a specific caller without regard to message subject matter. Similarly, a substitute recipient may be associated to a specific message subject matter without regard to the identity of the caller who left the message. Where there is a possibility of more than one possible substitute recipient for a given message, the choice of which of the alternate methodologies for identifying substitute recipients is to be given priority may be based on a recorded profile associated with the originally intended recipient.

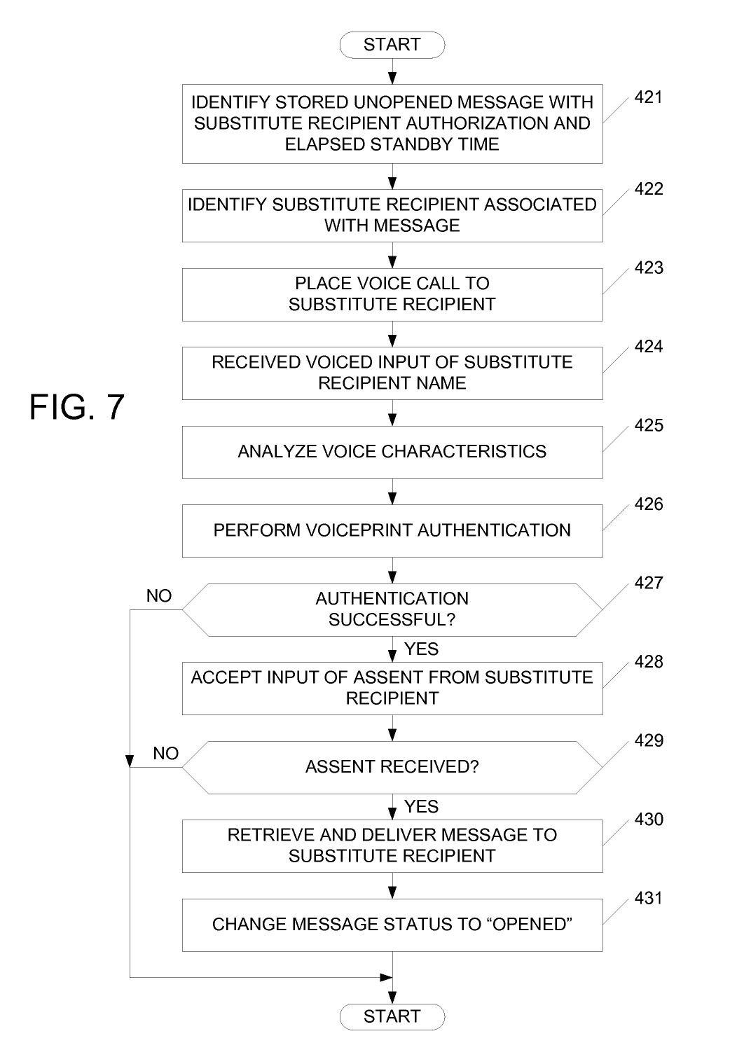

FIG. 7 is a flowchart illustrating typical operations of the system when determining whether to release a previously stored message to a substitute recipient.

In the message management apparatus 50, the DB management unit 55 identifies a message box containing a stored, previously unaccessed (i.e., UNOPENED) message for which a specified standby time has elapsed and which the caller has authorized for release to a substitute recipient (step 421). More specifically, the DB management unit 55 regularly monitors message information stored in the message storage unit 51. For each currently “UNOPENED” message that has been authorized for possible release to a substitute recipient, the amount of time that has elapsed since storage of the message is determined to see if the elapsed time equals of exceeds the specified standby time for the message. If the standby time has not been exceeded, no action is taken.

If, however, the standby time has been exceeded, the DB management unit 55 identifies the substitute recipient and retrieves the user ID associated with the substitute recipient.

The DB management unit 55 sends the user ID of the identified substitute recipient and a telephone number associated with the user ID to the dial-out unit 43 of the IVR 40 and instructs the dial-out unit 43 to dial the telephone number (step 423). The dial-out unit 43 sends the user ID to the voice response unit 41.

When the phone call is answered, the voice response unit 41 provides a synthesized voice message informing the answering party that a caller has asked that a stored message be accessed and prompts the answering party to respond with the party's own name. If the answering party responds with the expected name, the voice response unit 41 records the voice and directs it to the DB management unit 65 of the voiceprint authentication system 60 along with the user ID transmitted from the dial-out unit 43.

The DB management unit 65 in voiceprint authentication system 60 sends the recorded voice to the voice analysis unit 66 which analyzes the characteristics of the received voice (step 425) and forwards the voice characteristics to the DB management unit 65.

Subsequently, the DB management unit 65 authenticates the answering party using the stored template which is associated with the user ID (step 426).

The DB management unit 65 determines similarities between the stored template and the voice characteristics entered from the voice analysis unit 66 to determine whether the similarities exceed a predetermined threshold value.

If it is determined that the similarities between the answering party's recorded voice and the stored template associated with the previously identified substitute recipient exceeds the predetermined threshold value, the DB management unit 65 notifies the voice response unit 41 that the voiceprint authentication was successful (step 427). The voice response unit prompts the answering party (now assumed to be the designated substitute recipient to acknowledge a willingness to check the stored message (step 428). If the user acknowledges a willingness to check the stored message, that acknowledgement is directed to the DB management unit 55 of the message management apparatus 50.

The DB management unit 55 determines whether the substitute recipient has appropriately agreed to check the message (step 429). Assuming an affirmative outcome, the DB management unit 55 retrieves the stored message and sends it to the voice response unit 41 of the IVR 40 for delivery to the substitute recipient (step 430). Concurrently, the DB management unit 55 changes the message status from “UNOPENED” to “OPEN” in the message storage unit 51 (step 431).

On the other hand if either the voiceprint authentication performed in step 427 or the final check performed in step 429 have a negative outcome, the DB management unit 55 terminates processing without retrieving the message from storage.

Although the above description shows the substitute recipient being authenticated by voiceprint analysis, it is within the scope of the invention to authenticate the substitute recipient by other methods. For example, the answering party may be asked to provide a previously-established password either vocally or through the use of the telephone keypad. If the correct password is entered, the answering party is considered to be authenticated as the identified substitute recipient.

Variations in the embodiment described above may be provided within the scope of the invention. For example, an identified substitute recipient may be notified of the presence of an unopened message by means other than a telephone message; for example, through the use of an instant message or an e-mail message. It would, of course, be necessary for the system to store the e-mail address or other addressing information required to contact the substitute recipient in whatever communication environment is selected.

Still other variations will be within the scope of the invention. For example, if an initial attempt to contact a designated substitute recipient were unsuccessful, the system could make a follow-up attempt after a designated delay or redirect the message toward an alternate, substitute recipient.

Moreover, while the invention may be most useful in the voice messaging environment, the invention could be used in dealing with e-mail messages that remain on an e-mail server for an extended period of time without being opened by the original intended recipient.

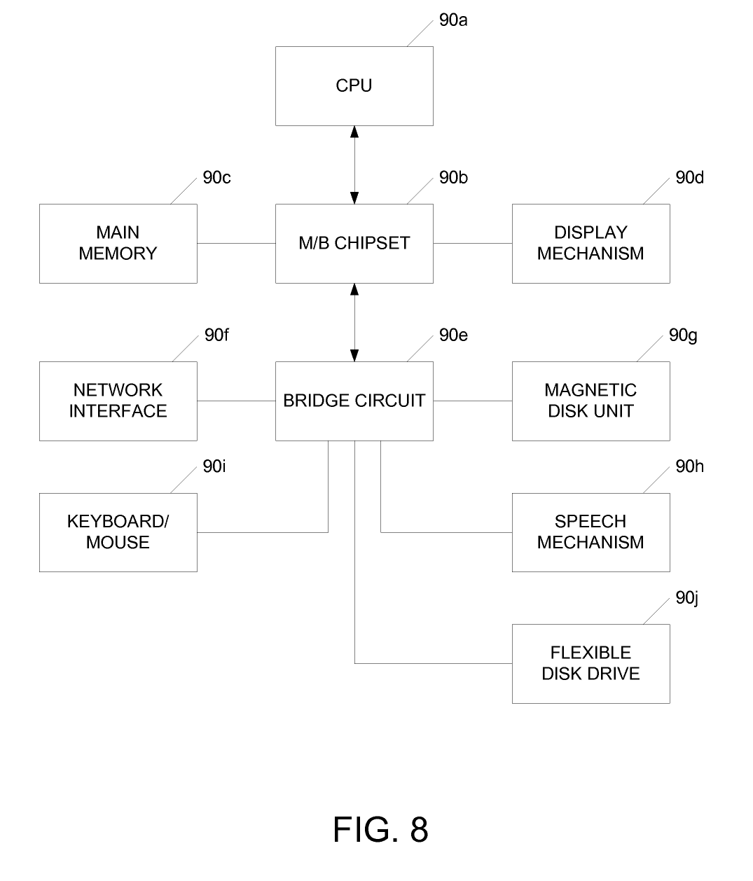

FIG. 8 illustrates a hardware configuration of a computer that may be used in implementing different embodiments of the invention. As shown, the computer includes a central processing unit (CPU) 90a, which is a computing means, a main memory 90c, which is connected to the CPU 90a via a motherboard (M/B) chipset 90b, and a display mechanism 90d, which is connected to the CPU 90a via the M/B chipset 90b similarly. Further, the M/B chipset 90b is connected to a network interface 90f, a magnetic disk unit (HDD) 90g, a speech mechanism 90h, a keyboard/mouse 90i, and a flexible disk drive 90j via a bridge circuit 90e.

In FIG. 8, the components are connected via buses. For example, the CPU 90a and the M/B chipset 90b or the M/B chipset 90b and the main memory 90c are connected to each other via a CPU bus. Moreover, the M/B chipset 90b and the display mechanism 90d may be connected via an accelerated graphics port (AGP), but if the display mechanism 90d includes a PCI Express compliant video card, the M/B chipset 90b and this video card are connected via a PCI Express (PCIe) bus. Moreover, if the M/B chipset 90b is connected to the bridge circuit 90e, for example, it is possible to use PCI Express bus for the network interface 90f. Further, for the magnetic disk unit 90g, for example, it is possible to use a serial ATA (AT Attachment) bus, a parallel transfer ATA bus, or a peripheral component interconnect (PCI) bus. Further, for the keyboard/mouse 90i and the flexible disk drive 90j, it is possible to use a universal serial bus (USB).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for managing access to stored electronic messages in an electronic messaging system comprising:
determining, at the time a message is presented for storage, whether the message originator storing the message will authorize release of the stored message to a substitute recipient if the original intended recipient does not access the stored message before a predetermined set of conditions occur;
if the message originator authorizes such a release,
identifying an authorized substitute recipient, and
storing the identity of an authorized substitute recipient in memory in association with the stored message;
upon occurrence of the predetermined set of conditions,
retrieving the identity of the authorized substitute recipient from memory; and
making the stored message available to the authorized substitute recipient.

2. The computer implemented method of claim 1 wherein identifying an authorized substitute recipient further comprises
identifying at least one potential recipient having an association with at least one of the identified message originator and the message subject matter; and
designating an identified recipient as the authorized substitute recipient.

3. The computer-implemented method of claim 2 wherein making the stored message available to the authorized substitute recipient further comprises;
attempting to authenticate the substitute recipient; and
if the substitute recipient is successfully authenticated, retrieving the stored message from memory and delivering it to the substitute recipient.

4. The computer-implemented method of claim 3 further comprising authenticating the message originator before storing the message in the electronic messaging system.

5. The computer-implemented method of claim 4 wherein the predetermined set of conditions comprises the lapse of a predetermined time period following storage of the message without the message having been accessed by the original intended recipient.

6. The computer-implemented method of claim 5 wherein the electronic message is a voice message, the electronic messaging system is a voice messaging system and at least one of the message originator and the authorized substitute recipient is authenticated by performing voiceprint analysis on a received voice message.

7. A computer program product for managing access to stored electronic messages in an electronic messaging system, said computer program product comprising a computer usable medium having computer usable program instructions recorded thereon, said computer usable program instructions when loaded onto and executed by a computer causing the computer to perform a method comprising:
determining, at the time a message is presented for storage, whether the message originator storing the message will authorize release of the stored message to a substitute recipient if the original intended recipient does not access the stored message before a predetermined set of conditions occur;
if the message originator authorizes such a release,
identifying an authorized substitute recipient, and
storing the identity of an authorized substitute recipient in memory in association with the stored message;
upon occurrence of the predetermined set of conditions,
retrieving the identity of the authorized substitute recipient from memory; and
making the stored message available to the authorized substitute recipient.

8. The computer program product of claim 7 wherein identifying an authorized substitute recipient further comprises
identifying at least one potential recipient having an association with at least one of the identified message originator or the message subject matter; and
designating an identified recipient as the authorized substitute recipient.

9. The computer-implemented method of claim 8 wherein making the stored message available to the authorized substitute recipient further comprises;
attempting to authenticate the substitute recipient; and
if the substitute recipient is successfully authenticated, retrieving the stored message from memory and delivering it to the substitute recipient.

10. The computer-implemented method of claim 9 further comprising authenticating the message originator before storing the message in the electronic messaging system.

11. The computer-implemented method of claim 10 wherein the predetermined set of conditions comprises the lapse of a predetermined time period following storage of the message without the message having been accessed by the original intended recipient.

12. The computer-implemented method of claim 11 wherein the electronic message is a voice message, the electronic messaging system is a voice messaging system and at least one of the message originator and the authorized substitute recipient is authenticated by performing voiceprint analysis on a received voice message.

13. An apparatus comprising:
an input unit for receiving electronic messages from message originators, said messages being intended for retrieval and delivery to original intended recipients;
a memory for storing an electronic message received through said input unit, an authorization from message originator for release of the stored message if the message is not accessed by the original intended recipient before a predetermined set of conditions occur, the predetermined set of conditions, and the identity of a substitute recipient; and
a memory management unit for determining whether the predetermined set of conditions occurs before the stored message is accessed by the original intended recipient and for making the stored message available to the substitute recipient if the predetermined set of conditions is determined to have occurred before the stored message is accessed by the original intended recipient.

14. The apparatus of claim 13 further comprising logic for identifying an authorized substitute recipient for a message based on at least one of the identity of the message originator and the subject matter of the message.

15. The apparatus of claim 14 further comprising an authentication unit for authenticating the substitute recipient before the message is retrieved from the memory for delivery to the substitute recipient.

16. The apparatus of claim 15 wherein said authentication unit further comprises logic for authenticating the message originator before the message is accepted for storage in the memory.

17. The apparatus of claim 16 wherein the electronic message is a voice message and the authentication unit comprises a voiceprint analysis unit for performing authentication based on voiceprint analysis.
